(19) United States
(12) Patent Application Publication
(10) Pub. No.: US 2007/0288666 A1
(43) Pub. Date: Dec. 13, 2007

(54) Apparatus of Computations and Communications Design on Cellular PC Modem

(75) Inventor: Ming-Jye Sheng, Basking Ridge, NJ (US)

Correspondence Address: Ming-Jye Sheng, 63 Hartley Lane, Basking Ridge, NJ, 07920, US

(73) Assignee: SYSAIR INC, Basking Ridge, NJ (US)

(21) Appl. No.: 11/741,763

(22) Filed: Apr. 29, 2007

Related U.S. Application Data
(60) Provisional application No. 60/746,078, filed on May 1, 2006.

(51) Int. Cl. G06F 13/12

(52) U.S. Cl. 710/64

(57) ABSTRACT

Partitioning Digital front end and digital signal processing across bus interface is carried out in PC and special circuitry Lower bandwidth of sampled I/Q signal communicated over USB bus is made feasible in the design Embodiments are applicable to architecture design of CPCM Card and CPCM embedded module. The CPCM embedded module can be applied to desktop PC, notebook PC, smart phone, smart USB module, and any other devices which require CPCM functionalities The technique lends itself to both board level and FPCA/ASIC implementations. The architecture is applicable to existing 3G/4G wireless standards, WCDMA, HSDPA, CDMA 2000, TD-SCDMA, and WiMAX,

### PRIORITY CLAIM

Applicants hereby claim the benefit of priority under 35 U.S.C. § 119 based upon U.S. Provisional Patent Application Ser. No. 601/746,078 filed May 1, 2006 in the names of the inventors hereof, commonly assigned herewith, the disclosure of which is hereby incorporated herein by reference as if set forth fully herein.

### TECHNICAL FIELD

The present disclosure relates generally to a new architecture for a Cellular PC Modem (CPCM). Specifically, new architecture for reducing bit width and over sampled rate of I/Q signal communication are provided to optimized computations and communications on Cellular PC modem implementation. The new design can reduce hardware cost of Cellular PC modem.

### TABLE OF ABBREVIATIONS AND ACRONYMS

The following table lists abbreviations and acronyms used herein and their corresponding meanings. See http://www.3gpp.org/ for 3GPP specification and acronyms used in this document.

3GPP 3rd Generation Partnership Project

ADC Analog to Digital Converter

AGC Automatic Gain Control

ASIC Application Specific Integrated Circuit

Carrier Cellular Data Telecommunications Provider

CPCM Cellular PC Modem

MRC Maxim Ratio Combining

PC Personal Computer

RF Radio Frequency

RX Receive

RRC Raise Root Cosine

SDR Software Defined Radio

TX Transmit

UE User Equipment

USB Universal Serial Bus

UTRAN UMTS Terrestrial Radio Access Network

WCDMA Wideband Code Division Multiple Access

### BACKGROUND

The architecture is related to the following pending patents.
The apparatus for synchronization and adaptive resource management for cellular PC modem, U.S. Ser. No. 11/493,370
the apparatus of rake receiver on the cellular PC modem, U.S. Ser. No. 11/698,783

Traditional Software definable radio design uses 4 times over sampled I/Q signals with 16 bits resolution. See Vanu Inc's paper [RF over Ethernet for wireless infrastructure by Gerald Britton, Byron Kubert and John Chapin, Vanu Inc., 2005 Software Defined Radio Technical Conference, Orange County, Calif., November 2005.]. FIG. 1A shows direct application of the same model to CPCM design.

In FIG. 1A. RF (1) down converts RF signal to analog baseband signal (2) Analog baseband signal is then converted to digital baseband signal (7) by ADC (3). Bus device (4) and Bus Host (8) are used to communicate the digital baseband signal (7) to digital baseband unit (14) for further processing. The digital baseband unit (14) output bits (15) for other bit processing unit to process, Notice that USB2 bus is used in following examples. Other bus (for instance, PCI High speed Ethernet) can work provided its bandwidth and QoS characteristics satisfy communication requirements. The digital baseband signal (7) is also sent to AGC (12) through Host bus (8) and (10). ACC calculates power and adjust RF (1) receiver front end gain through links (9),(6),(5) so that digital baseband signal (7) falls into A/D converter's (3) dynamic range most of the time.

Following table shows bandwidth requirement for the traditional SDR design. Total chip samples data transfer can be computed as follows:

| | | RX: 4 times | | |
|---|---|---|---|---|
| | I/Q Sample | Over sampled | TX: sampled | Total sampled |
| Sample | size | data | data | data |
| rate | (bytes) | (bytes/s) | (bytes/s) | (bytes/s) |
| 3.84M | 4 | 61.44M | 15.36M | 76.8M |
| samples/s | | | | |

### OVERVIEWV

Relocating baseband processing inside PC post challenges of supporting inner loop power control and paging indicator detection for CPCM (CDMA based system) implementation. The main reason is due to the delay across PC System Bus (PCI, USB, etc.). In order to reuse the CPU in PC for baseband processing, the new communication design is added into ASIC to reduce I/Q. chip data communication between PC and CPCM, a new computation model is devised to reduce I/Q chip demodulation with minimum delay and hardware.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1A is a bock diagram illustrating traditional software definable radio architecture for CPCM design;

FIG. 1B is a block diagram illustrating computational model used in the new CPCM design;

FIG. 2 is a block diagram illustrating AGC design in the new CPCN design;

FIG. 3 is a block diagram illustrating new rake receiver design;

FIG. 4 is a block diagram illustrating new symbol demodulator design.

### DESCRIPTION OF EXAMPLE EMBODIMENTS

Example embodiments are described herein in the context of a CPCM operating in conjunction with a service scheme provided by a cellular data telecommunications provider (carrier). Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and describe. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, jump Drive, and the like), magnetic storage medium (e.g., tape, magnetic disk drive, and the like), optical storage medium (e.g., CD ROM, DVD-ROM, paper card, paper tape and the like) and other types of program memory.

I/Q chip resolution with short or byte size, and number of over sampling rate determines amount of information crossing USB port and it also affects CPU resource requirement. The new design not only reduces communication requirement over USB bus but also provides the following benefits.
Reduce USE memory requirement by 4 times [Memory save]
Reduce USE memory access by 4 times [CPU resource save]

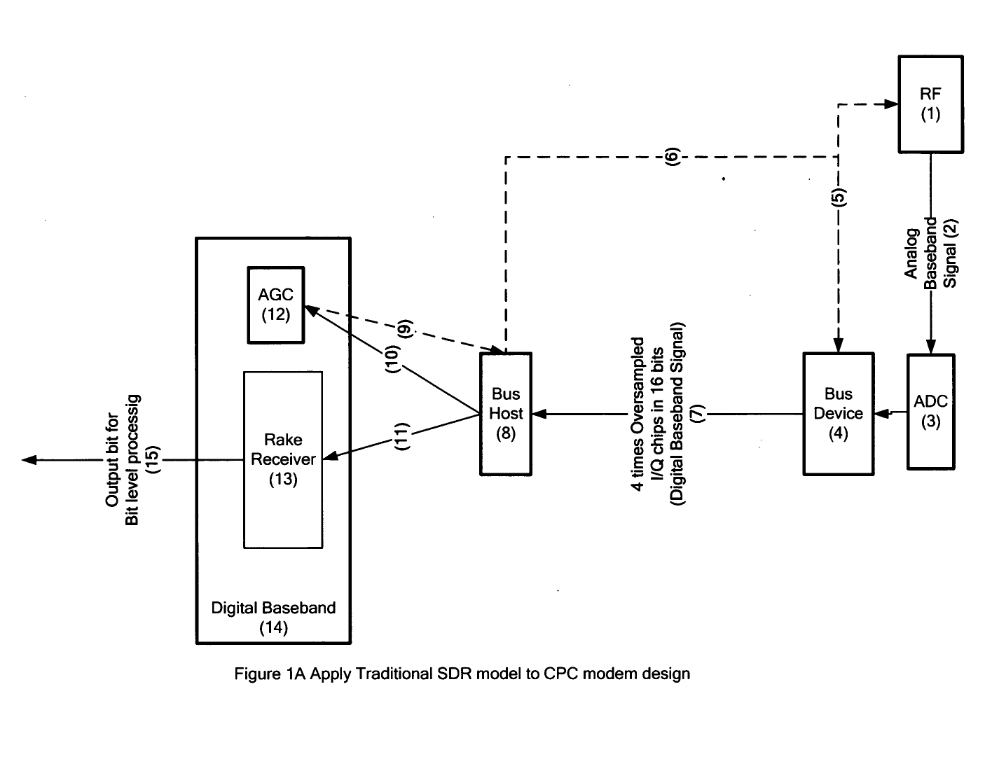

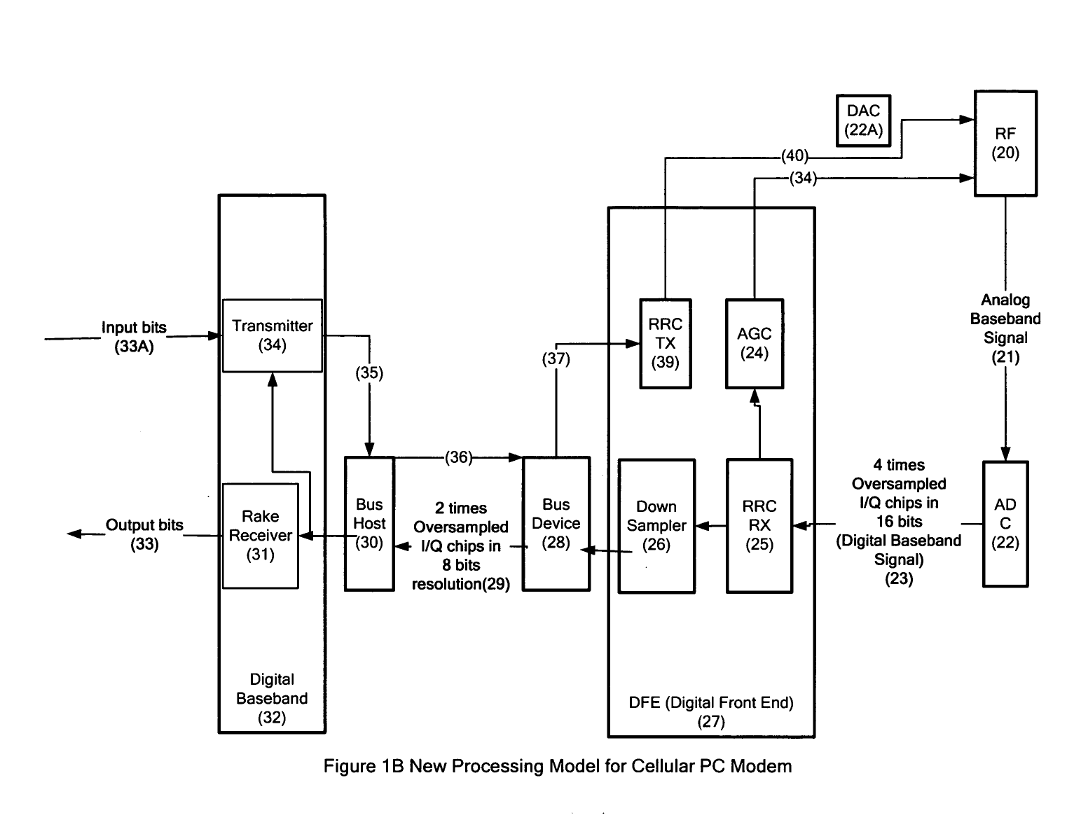

We change I/Q chip data size from short to byte to allow lower communication requirement than traditional design. Unlike traditional SDR design of using 4 times over samples I/Q chips for WCDMA, 2 times over sampled I/Q chip samples is used. See FIG. 1B for illustration.

In FIG. 1B, RF (20) down converts RF signal to analog baseband signal (21). Analog baseband signal (21) is then converted to digital baseband signal (23) by ADC (22). Bus device (28) and Bus Host (30) are used to communicate the optimized digital baseband signal (29) to digital baseband unit (32) for further processing. The digital baseband unit (32) output bits (33) for other bit processing unit to process. Notice that USB2 bus is used in following examples. Other bus (for instances PCI, High speed Ethernet) can work provided its bandwidth and QoS characteristics satisfy communication requirements. The digital baseband signal (23) is also sent to ACC (24) through RRC filter (25). AGC calculates power and adjust RF (20) receiver front end gain through links (34) so that digital baseband signal (23) falls into A/D converter's (22) dynamic range most of the time. The digital baseband signal (23) is further optimized by Digital Front End (27) and output optimized digital baseband signal (29) On the transmission side, the bits (33A) are input to Transmitter (34) of Digital baseband unit (32). The Transmitter (34) calculate and add time slot ID and Tx_offset (35A) into the I/Q chips, and then send the I/Q chips to Bus Device (37) through link (35,36). Bus Device (37) synchronizes the transmission of I/Q signal to RRC filter TX (39) with Tx_offset and bus delay. The filtered signal (40) is converted to analog signal by DAC (22A) and then output to RF (20).

Following table shows received optimized digital baseband signal (29), Total samples data transfer can be computed as follows:

| | | RX: 2 times | | |
|---|---|---|---|---|
| | I/Q Sample | Over sampled | TX: sampled | Total sampled |
| Sample | size | data | data | data |
| rate | (bytes) | (bytes/s) | (bytes/s) | (bytes/s) |
| 3.84M | 2 | 15.36M | 7.68M | 23.04M |
| samples/s | | | | |

Down sampler (26) is located in DFE (27) to work with the AGC function. It reduces sample rate from 4 times or higher to 2 times over sampling I/Q chips using decimation filters.

In FIG. 1B, Transmitter (34) receives continuous bits (33A) and prepare I/Q chips and transmit I/Q chips to the DAC unit (22A). Time slot boundary can be calculated by cell search procedures [See ftp://ftp.3gpp.org specification TS25.21 4]. Define Tx_offset as the number of chips between the incoming time slot boundary from bus interface and the time slot biundary calculated by cell search procedure. The Bus Device (37) is working with limited time slots buffer Proper time slot number synchronization between Transmitter (34) and Bus Device (37) take bus delay (35, 36) and TX_offset into account and shown below.
1. TSID (time slot ID) parameter is added for every 2560 chips in RX I/Q chip of Bus device (28) and send to transmitter (34) through (29,30).
2. TSID=0 . . . 60. This value, is defined with maximum of 4×5 time slots. But, depends on bus delay, this maximum size could be decreased down to 5 time slots.
3. TSID increases every 2560 chips, new TSID=(current TSID+1) mod 60.
4. On cell search process, it determines frame boundary.
5. On frame boundary, internal time slot counter value is zero.
6. On frame boundary, TX_offset=N mod (15*2560) where N is the pointer to RX I/Q chip buffer.
7. Transmitter (34) add the TX TSID and Tx_offset to every 2560 chips of TX I/Q chip buffer and send through links (35,36) to time slot buffer of Bus device (37)
8. The Bus device receives interrupt for every 2350 chips received in RX I/Q buffer. It transmit the 2350 chips in TX I/Q buffer at the time of interrupt with delay of TX_offset. The transmission is sent to RRC TX (39) and then DAC (22A) for converting to analog signals

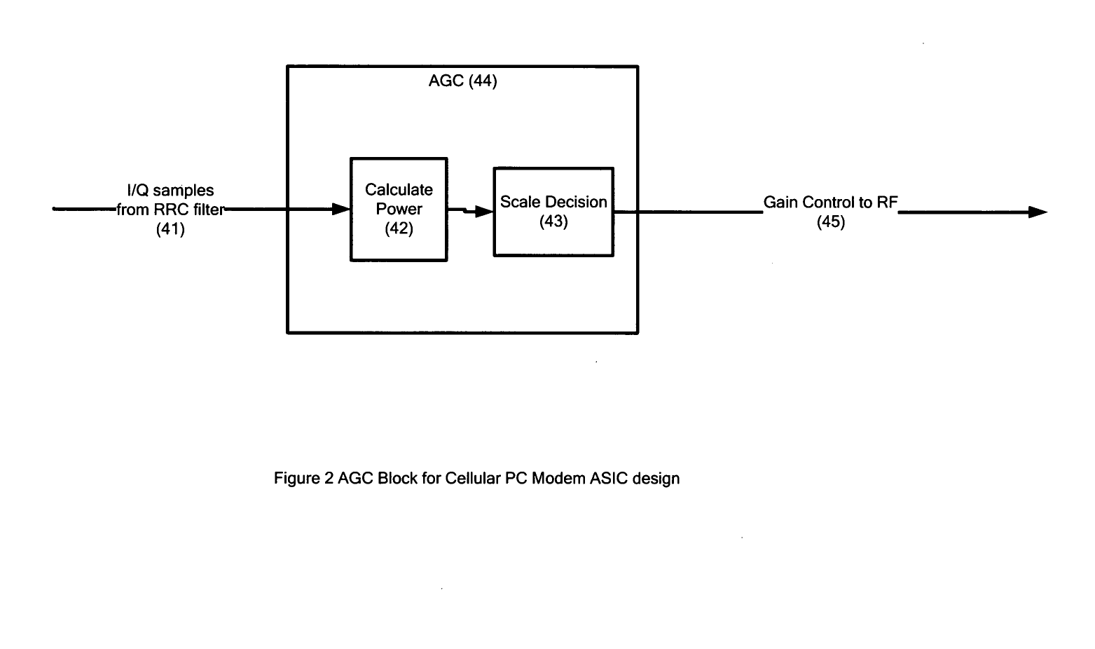

Automatic Cain Control or ACC (24), is located in DFE (27). It's main function is to adjust receiver front end gain so that demodulated baseband I and Q channel signal (23) falls into A/D converter's (22) dynamic range most of the time, despite path loss and fading present in wireless channel. The AGC function works with the RRC filtering (25) and changes incoming I/Q chip data size from short to byte. See FIG. 2 for illustration.

In FIG. 2, AGC (24) performs to reduce 12 to 13 bit ADC chips to 8 bit chip samples. The power is calculated at the output of RRC filter and used to control the variable amplifiers in the RF unit (20). Calculation of the power (42) after the digital RRC filter prevents the ACC from being influenced by out of band signals. Hence the AGC operates on the wanted inband signal only. Scale decision unit (43) allows truncation of the bit width of I/Q signal to within 8 bits. [Reference to Section 2.4.5 of WCDMA requirements and practical design by Rudolf Tanner and Jason Woodard, 2004, published by John, Wiley & Sons, Ltd]

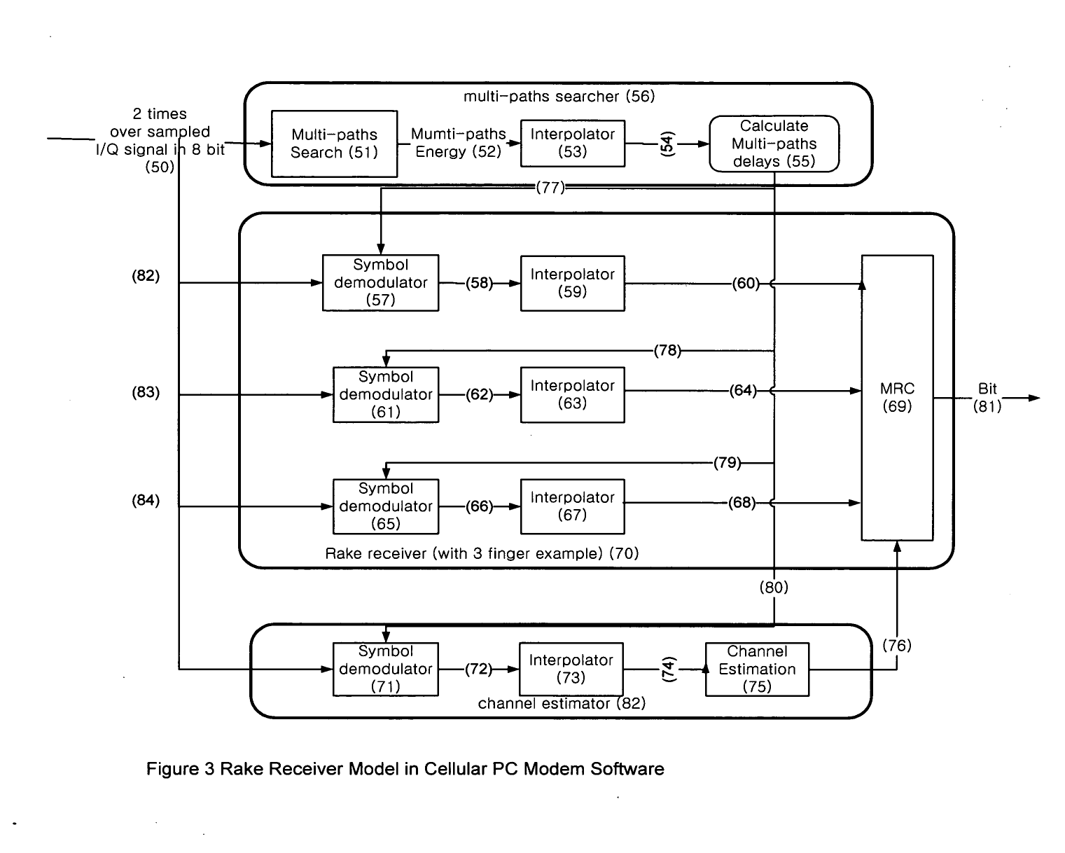

The new rake receiving process starts with the optimized digital baseband (50) and produces maximum ratio com bines symbols, then output bits (81). See FIG. 3 for illustration. Since these operations are working with 2 times of over sampled chip rates to extract the multi-paths combined symbols, interpolation is used to compensate performance degradation due to reduced over-sampling rate. See paper [complexity analysis of an interpolation based rake receiver for WCDMA systems, by Babak Soltanian, Vesa Lehtinen, Elena Simona Lohan and Markku Renfors, Tampere University of Technology, Telecommunications Laboratory, IEEE Telecommunications Conference, GLOBECOM, 2001.].

Digital baseband unit (32) is a computation intensive application. Parallel processing using very long instructions (such as MMX instructions of PC main processors) coding speed u p multiply and accumulation operations by 16 times with the 8 bit data size. MMX is a SIMD instruction set designed by Intel, introduced in 1997 in their Pentium MMX microprocessors. For instance, with the 1.0 Hz processor clock speed, we can multiply and accumulate 8 to 16 Giga times a second. In addition to the MMX optimized application, memory access requires large amount of processor clocks. Cache memory size shows significant performance differences, and larger cache buffer size would enhance the real time performance.

In FIG. 3, A rake receiver allocates one rake finger to each multipath (81, 82, 83), thus maximizing the amount of received signal energy. The rake receiver combines in MRC (69) these different paths into a composite signal with substantially better characteristics for demodulation than a single path. To combine the different paths meaningfully the rake receiver needs such channel parameters as the number of paths, their location (in the delay profile), and their (complex valued) attenuation. The number of paths and delay profile are maintained by multi-path searcher (56). The necessary channel parameters must be estimated and tracked throughout the transmission by channel estimator (82). The objective of the channel estimation block is to estimate the channel phase and amplitude for each of the identified paths. Once this information is known, it can be used for combining each path of the received signal. In symbol rate combining, the data of multiple paths is demodulated and stored in symbol demodulator (57, 61, 65). However, each path is in symbol level and interpolated by interpolators (59, 63, 67),

Channel estimation is estimated at the symbol level (71) and interpolated (73) to the chip level. Therefore, symbol-level channel estimation requires fewer CPU instruction cycles than chip level estimation.

Symbol-level combining, as its name implies, combines the signals of different paths at the symbol level. The descrambling and despreading are performed in symbol demodulators (57, 61, 65) before combining in order to convert chip-level signals into symbol-level signals. The same symbols obtained via different paths are then combined using the corresponding channel information and a combining scheme such as MRC (Maxim Ratio Combining) (69).

A multi-path searcher (56) estimates the delay for the different paths. Each path energy is calculated in (51) and then interpolated in (53). The delay profile of multipath is then estimated in (55). Then the received signal (82, 83, 84) is delayed by the amount estimated by the path searcher through links (77, 78, 79) and multiplied by the scrambling and spreading code in symbol demodulators (57, 61, 65). The descrambled and despread data (58, 62, 66) are then interpolated by interpolators (59, 63, 67) over one symbol period.

In the design, first order Lagrange interpolator is used for interpolators (73) of channel estimation and second order Lagrange interpolator is used for interpolators (53, 59, 63, 67) of multipath searcher and MRC combiner.

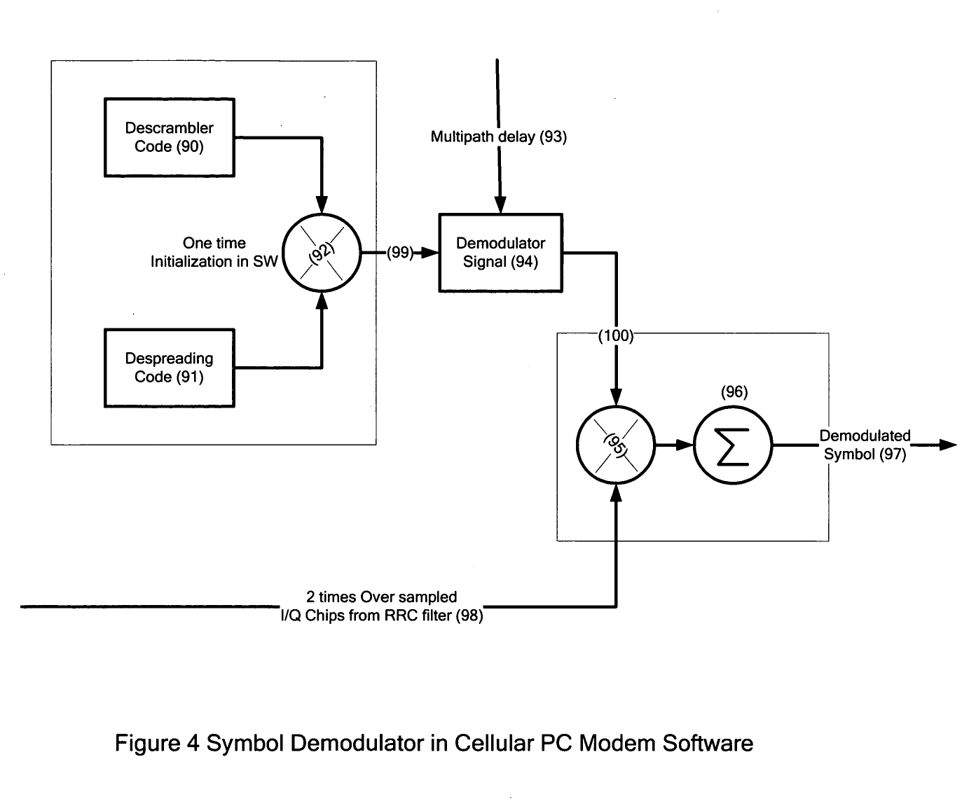

The block of symbol demodulator (57, 63, 65, 73) implementation is done with efficient MMX coding and functional redesign. See FIG. 4 for illustration.

In FIG. 4, the design combines two functions in one, and produces static demodulator signal. With determined scrambler code, the scrambler (90) is executed once to produce one whole frame of scrambler output initially. Also, one whole cycle of OVSF code generation is done initially in (91). These operations may require more memory, but it save s run time resource significantly. One of the benefits of using PC platform is that we can use large amount of memory resources already designed into the PC platform itself. Now that Descrambler and OVSF demodulator combined symbols (92) are pre-computed as demodulator signal (94) and stored in PC memory buffer. (95) compares incoming over sampled I/Q chips (98) with the demodulator signal (94). All (95) needs to do is to multiply and accumulate with two buffer contents pointed by multi-path profile (93). The multi-path profile is coming from links (77, 78, 79) of FIG. 3. The usage of MMX instructions in PC main processors for 128 bit data I/O operation, and MMX parallel operation speed up the demodulation process further. The demodulated signals are stored for a period of symbol as represented in (96).

What is claimed is:

1. An architecture for a Cellular PC Modem (CRCM) in which I/Q chip samples are processed, the architecture comprising:
dedicated hardware for reducing sampling rates and bit width of I/Q chip samples and
an external interface unit for communicating I/Q chip samples to an external processor of a computing device to which the CPCM may be coupled for processing.

2. The architecture of claim 5, wherein the CPCM is additionally configured to synchronize the transmission timing of I/Q signal with the receiving timing of I/Q signal calculated by an external processor of a computing device to which the CPCM may be coupled for processing.

3. The architecture of claim 1, wherein the DFE is additionally configured to reduce bit width of the receiving timing of I/Q signal converted from ADC.

4. The architecture of claim 1, wherein the Digital Baseband s additionally configured to reduce sample rate with interpolators for multi-path search, rake receiver and channel estimation.

5 A method comprising:
Reducing sample rate of I/Q chip samples;
Reducing bit width of I/Q chip samples;
Synchronizing protocol for receiving and transmission timing; and
Compensating signal loss of under sampling with interpolators of multi-path search, rake receivers, and channel estimation; and
Partition of digital base band function into Digital front end and chip level processing
wherein the partition distribute the functions across bus (USB, PCI, etc.)

6. The method of claim 5, further comprising:
Automatic gain control in digital front end for bit width reduction

7. The method of claim 5, further comprising:
Symbol demodulators and interpolators for reducing hardware and computation complexity

8. An apparatus comprising:
means for reducing over sampled data rate to communicate I/Q sample data through bus;
means for synchronizing RX and TX I/Q signal between digital front end and digital baseband processing;
means for using PC memory in pre-computing reference symbols and speed up processing;
means for interpolators usage in rake receiver;
means for interpolators in multipath search; and
means for interpolators in channel estimation
